(19) United States
(12) Patent Application Publication
(10) Pub. No.: US 2010/0018312 A1
(43) Pub. Date: Jan. 28, 2010

(54) Pipe Location System

(75) Inventors: Peter Eugene Kirkpatrick, San Francisco, CA (US); Thomas Bruno Mader, Los Gatos, CA (US)

Correspondence Address: Peter Kirkpatrick, 2977 23rd St, San Francisco, CA, 94110, US

(73) Assignees: Peter Eugene Kirkpatrick, San Francisco, CA (US); Thomas Bruno Mader, Los Gatos, CA (US)

(21) Appl. No.: 12/180,562

(22) Filed: Jul. 28, 2008

(51) Int. Cl. G01N 29/00

(52) U.S. Cl. 73/592; 340/605

(57) ABSTRACT

A method and apparatus for the remote detection of non-conductive pipes is described. The system consists of transmitter (Tx) and receiver (Rx) units. The transmitter unit induces mechanical vibrations into the pipe, and generates a reference signal which is relayed to the receiver. The receiver unit senses vibrations from the ground and converts the vibrations into an electrical signal, and receives the reference signal from the transmitter. Using synchronous detection, the receiver compares the reference signal to the received signal from the ground. The output of the receiver is proportional to the strength of the signal from the ground and therefore indicates the proximity of the receiver to the underground pipe.

### FIELD OF THE INVENTION

The present invention relates to underground utility pipe location and, more particularly, to improving the accuracy and range of non-conductive utility pipe locating equipment.

### BACKGROUND OF THE INVENTION

Many utilities such as electricity, communications, water, gas, and sewer are transported in pipes and buried underground in all parts of the world. For a variety of reasons, the locations of these utilities must be known accurately. For example, a pipe carrying the utility may be broken and must be repaired. Or another construction project in the area may require digging for an unrelated reason, but the digging must avoid the existing utilities. Often, the maps that describe the locations of such utilities are non-existent or inaccurate. If the pipe cannot be located accurately, the costs of excavation and the time spent on the job increase dramatically. The safety of the equipment operators and disruption to the utility and traffic also become major concerns.

Therefore, all cities, utilities, contractors, and others involved in construction require equipment that can accurately locate pipes of all varieties. When the situation requires the location of a conductive (metal) pipe, the equipment and methods used can be very effective. These systems generally induce an electrical signal onto the pipe, which conducts down the pipe easily due to the metals low resistance to electrical current. The signal also radiates from the pipe along its length, including radiation toward the surface of the ground. An electrical receiver can easily detect this signal and indicate the strength of the signal to an operator.

Utilities such as water and gas are commonly carried in non-conductive (plastic) pipes. These pipes do not conduct the electrical current that enables the method used on conductive pipes. Therefore, other methods are used which are described in the prior art section. These methods have been found unsatisfactory for the reasons described there, and the present invention is proposed as a solution.

Leak Detector. One implementation of such a system consists of a receiver, commonly used and marketed as a ‘leak detector’, a microphone, and a sound generation unit. The sound generation unit (a ‘thumper’) is attached inline with the pipe in an exposed section, usually near the meter. The thumper modulates the pressure of the liquid in the pipe to generate a traceable signal. The operator then uses the microphone, commonly a ground microphone amplified by the receiver, to listen for the sound emitted from the pipe into the ground. Based on the perceived strength of the signal, the operator marks the location of the pipe. The receiver generally employs a low-pass filter to remove noise from the signal. The leak detector technique is limited in sensitivty by the bandwidth of the low-pass filter, and also limits the upper range of frequencies that may be used for the signal. The technique is also susceptible to environmental noise such as traffic. The method may require destructive modification of the pipe in order to attach the thumper inline, which is costly and time consuming. The method does not work on pipes that carry gas or pipes that are not pressurized, for example when the pipe is broken which is a common reason for the locate.

Sonde. A ‘sonde’ is a device that can pass through the pipe and wirelessly transmits an electrical signal which is detected by a receiver. This method can provide a strong signal and therefore accurate results. The sonde technique has limitations, however; using a sonde may require destructive modification of the pipe in order to insert the sonde. The sonde must also be recovered after the locate is complete.

Ground Penetrating Radar. A ‘ground penetrating radar’ system transmits an electrical wave into the soil and detects the waves that are reflected at different delays. Based on the time delay and strength of the reflected pulse, the system can determine the distance and composition of the underground landscape, including pipes. However, such a system is very expensive and limited in accuracy by various soil conditions. For example, the amount of power that the system can transmit into the soil is limited, as close reflections can saturate or overload the detector and prevent other signals from being detected accurately. Various frequencies are also not useful due to the reflection and transmission characteristics of certain soil types at those frequencies.

It would be advantageous to provide a system with improved sensitivity and noise rejection. By utilizing the principle of synchronous detection, the present invention provides a method and implementation for improving the sensitivity and noise rejection of the acoustic receivers used in existing systems. Improved sensitivity results in extending the distance from the meter that underground non-conductive pipes may be located. Increased noise rejection means that pipes can be located in noisy environments such as construction sites or near busy streets.

It would also be advantageous to provide a system with increased precision. Improved sensitivity also provides for locating non-conductive pipes with increased precision. This results in less digging when excavating pipes and fewer errors that can result in cut or broken pipes.

It would also be advantageous to provide a system with automated feedback and ease of use. Due to the nature of the received signal strength indication, the present invention reduces the need for human skill in the location of pipes, as automatic feedback is provided to the operator. The locate is dependent on the precision of the instrument and not the trained ear of a specialized operator.

It would further be advantageous to provide a system with signal optimization. By transmitting a copy of the original signal to the receiver via an independent link, the ability to tune the signal waveform in terms of frequency, pulse shape, etc. provides a mechanism to optimize the signal propagation. Signal characteristics may be selected that propagate better in certain soil or environmental conditions, which can further extend distance and accuracy of the locate. For example, bursts of signal may be employed to discern ‘multipath’ propagation. By using an external (to the pipe) mechanical transducer and synchronous detection, a much wider range of useful frequencies are available for optimal system performance.

It would further be advantageous to provide a system with non-destructive operation. The current invention may be used to locate pipes without disconnecting or modifying the pipe or attachments. Due to the wider range of frequency of operation, a frequency range may be found that requires less transmit amplitude, which can prevent damage to the pipe, meter, and other connections.

It would further be advantageous to provide a system with low cost. The current invention may be implemented using low frequency analog components or straightforward digital signal processing hardware. The components are commonly available at low cost.

### SUMMARY OF THE INVENTION

In accordance with the present invention, there is provided a method and apparatus for the remote detection of non-conductive pipes. The system consists of transmitter (Tx) and receiver (Rx) units. The transmitter unit is attached mechanically to the pipe to be located. The transmitter induces mechanical vibrations into the pipe, and generates a reference signal which is relayed to the receiver.

The receiver unit senses vibrations from the ground and converts the vibrations into an electrical signal, and receives the reference signal from the transmitter. Using synchronous detection, the receiver compares the reference signal to the received signal from the ground. The output of the receiver is proportional to the strength of the signal from the ground and therefore indicates the proximity of the receiver to the underground pipe.

Beyond the basic operation of the current invention, advanced techniques may be employed to increase the performance and functionality of the system. For example, a calibration or optimization routine may be used to determine the optimal frequency and signal characteristics to improve location in various underground conditions. For example, the frequency of the transmitted signal may be swept from low to higher frequencies, to determine which frequency propagates the furthest under the given conditions.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram view of a transmitter and receiver system coupled to a non-conductive pipe in accordance to the invention;

FIG. 2 is a block diagram view of a synchronous detector as shown in FIG. 1; and

FIG. 3 is a block diagram view of an example utility location application of the non-conductive pipe locating system shown in FIG. 1.

For purposes of clarity and brevity, like elements and components will bear the same designations and numbering throughout the Figures.

### DESCRIPTION OF THE PREFERRED EMBODIMENT

The current invention describes a method and apparatus for the remote detection of non-conductive pipes. The system comprises a transmitter 200 (Tx) unit and a receiver 300 (Rx) unit, with a reference link 400 between them.

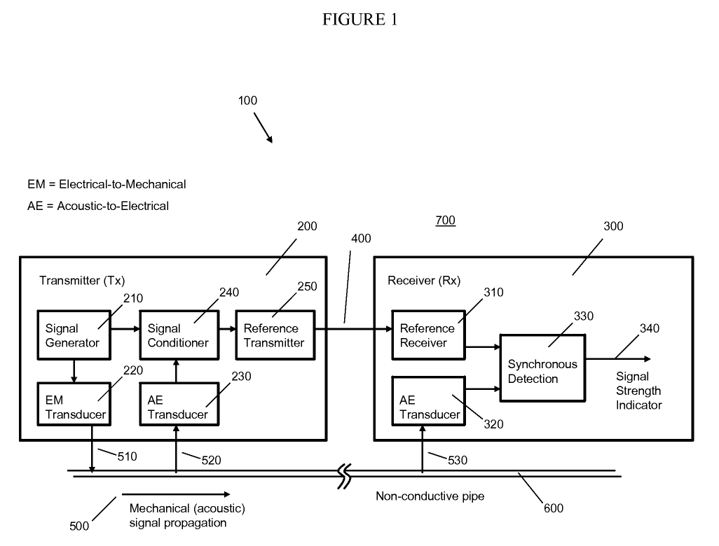

A block diagram of the pipe location system 100, including transmitter 200 and receiver 300 units is shown in FIG. 1. The transmitter 200 unit is attached mechanically to the non-conductive pipe 600 to be located where it is accessible above ground 900. The transmitter 200 contains a signal generator 210 circuit which generates a periodic electrical signal of sinusoidal or pulsed waveform. The signal is converted to a mechanical signal 510 and coupled to into the non-conductive pipe 600 using a transmitter transducer 220. The transmitter transducer 220 is an electrical-mechanical (EM) transducer. The signal characteristics and EM transducer are adapted to launch a mechanical local signal 520 that propagates in the material of the pipe in the axial direction. The signal propagation 500 in the axial direction of the pipe is indicated.

The transmitter 200 also provides a reference link 400 to the receiver 300. The transmitter 200 may produce the reference link 400 in various ways. In one embodiment, the signal generator 210 provides the reference link 400 directly to the reference transmitter 250. In an alternate embodiment, the transmitter 200 includes a transmitter detector 230. The transmitter detector 230 may be an mechanical-to-electrical (EM) or acoustic-to-electrical (AE) transducer, such as a ‘ground microphone’ or sensor coupled directly to the pipe, which can sense the local signal 520 and convert the local signal 520 back to an electrical signal. The advantage of using the transmitter detector 230 is that the reference signal is a more accurate representation of the remote signal 530 due to distortions in converting the electrical signal into a mechanical signal 510, and coupling the mechanical signal 510 to the pipe. The signal presented to the reference link 400 may be filtered or amplified by a signal conditioner 240 before being coupled to the reference transmitter 250. The transmitter 200 relays the reference link 400 to the receiver 300 via a wireline or wireless communication channel. The reference link 400 may operate in analog or digital fashion.

The receiver 300 unit includes a receiver detector 310 (acoustic-to-electrical or AE transducer) that can sense the remote signal 530 radiated from the non-conductive pipe 600 through the ground 900. The acoustic-electrical transducer converts the vibrations of the remote signal 530 into an electrical signal. The receiver 300 also contains a reference receiver 320 to detect the reference signal on the reference link 400. Using a synchronous detector 330, the receiver 300 compares the reference link 400 to the remote signal 530. The synchronous detector 330 may consist of a lock-in amplifier. The output of the synchronous detector 330 is proportional to the strength of the remote signal 530. The received signal strength indicator 340 (SSI) is used by the system operator to determine the location of the non-conductive pipe 600 underground; the pipe is generally directly under the location with the highest signal strength. The SSI signal can be displayed visually on a meter (analog or digital), via an audio tone, or electrically to external circuits.

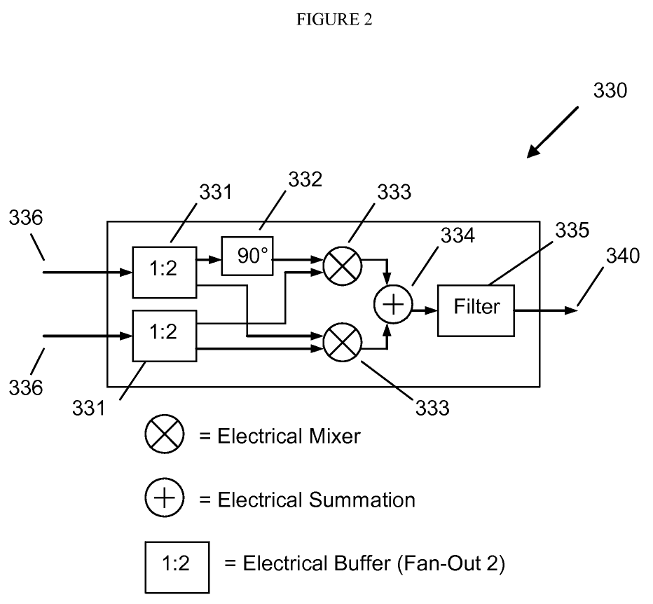

The synchronous detection is achieved by the use of a circuit called a lock-in amplifier. An example of a two-phase lock-in amplifier is shown in FIG. 2. The lock-in amplifier is used to determine the amplitude and phase of a periodic (repetitive) signal buried in noise. It achieves this by acting as a narrow bandpass filter which removes unwanted noise while allowing the signal which is to be measured to pass through. The reference link 400 is used to set the passband region of the filter. Given that the reference link 400 persents a signal that is a copy of the remote signal 530 to be detected, the system benfits from greatly improved sensitivty and noise rejection. In the example of FIG. 2, each input signal 336 is presented to an electrical buffer 331, which produces two identical copies of the input signal 336. In this example, the detected reference link 400 is connected to the upper input. One of the outputs of the upper buffer is connected to a phase shifter 332, which produces a phase shift of ninety electrical degrees in the signal at its output. The detector contains two instances of an electrical mixer 333 to electrically multiply the outputs of the respective buffers. The output signals from the mixers are presented to the electrical summation 334 element, whose output is proportional to the relative strength of the input signals. The output of the summation may be passed through an output filter 335 in order to remove unwanted characteristics of the signal. The output of the synchronous detector 330 is the received signal strength indicator 340. Those skilled in the art will recognize that this is only one of many ways to construct a synchronous detector 330.

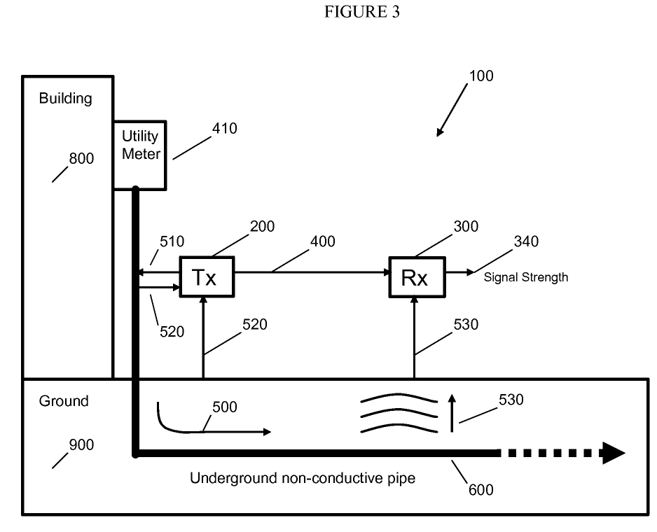

An example utility location application of the non-conductive pipe 600 locator system is shown in FIG. 3. In this example, a non-conductive pipe 600 is connected to a utility meter 410 on the side of a building 800. The transmitter 200 is attached to the pipe near the utility meter 410 where the pipe is exposed above the ground 900. The transmitter 200 couples the mechanical signal 510 into the pipe which travels in the direction of the signal propagation 500. This example indicates two possible methods of coupling the local signal 520 to the acoustic-electrical transducer. One method couples the local signal 520 directly from the pipe at the transmitter 200. Another method couples the local signal 520 from the ground 900. In an alternative embodiment, the local signal 520 is generated internally to the transmitter 200. The transmitter 200 relays a copy of the local signal 520 to the receiver 300 via the reference link 400. The reference link 400 may be transmitted wirelessly or via a wireline communications channel such as an electrical cable. The receiver 300 detects the signal from the reference link 400 and detects the remote signal 530 radiating through the ground 900 from the pipe, synchronously detects the signals, and indicates the relative strength of the signal from the pipe. When the receiver 300 is closer to the pipe, the received signal strength indicator 340 reports a stronger signal, therefore reporting the location of the pipe. The operator can mark the location of the pipe according to the areas of strong signal feedback from the system.

Beyond the basic theory of operation of the current invention, advanced techniques may be employed to increase the performance and functionality of the system. For example, a calibration or optimization routine 700 may be used to determine the optimal frequency and signal characteristics to improve location in various underground conditions. For example, the frequency of the transmitted signal may be swept from low to higher frequencies, to determine which frequency propagates the furthest under the given conditions. The signal envelope or pulse shape may also be tuned to optimize propagation under the current pipe and soil conditions.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A pipe location system for determining the location of non-conductive pipes, comprising:
a transmitter, for generating a periodic signal for coupling to the pipe and sending a reference signal to the receiver;
a receiver, for receiving the reference signal and detecting the signal from the pipe;
a reference link, for coupling the reference signal from the transmitter to the receiver;
a synchronous detector, for extracting the detected signal from the pipe from background noise; and
a received signal strength indicator, for indicating the relative strength of the signal from the pipe.

2. The pipe location system as recited in claim 1, further comprising:
a periodic signal generator, for generating signals to be coupled into the pipe and transmitted to the receiver.

3. The pipe location system as recited in claim 1, further comprising:
a transmitter transducer, for converting the electrical signal to a mechanical signal and coupling the mechanical signal from the transmitter into the pipe.

4. The pipe location system as recited in claim 1, further comprising:
a reference transmitter, for transmitting the reference signal to the receiver.

5. The pipe location system as recited in claim 1, further comprising:
a transmitter detector, for detecting the local signal from the pipe and converting the signal into an electrical signal.

6. The pipe location system as recited in claim 1, further comprising:
a receiver detector, for detecting the remote signal from the pipe and converting the acoustic signal to an electrical signal.

7. The pipe location system as recited in claim 1, further comprising:
a reference receiver, for detecting the signal from the reference link.

8. The pipe location system as recited in claim 1, further comprising:
an optimization routine, for optimizing the signal for maximum propagation under specific soil conditions.

9. The pipe location system as recited in claim 1, wherein said reference link has characteristics selected from the following group: wireless, and wireline.

10. The pipe location system as recited in claim 1, wherein said synchronous detector is a lock-in amplifier.

11. The pipe location system as recited in claim 1, wherein said received signal strength indicator has characteristics selected from the following group: visual, audio, and electrical.

12. The pipe location system as recited in claim 2, wherein said signal generator has characteristics selected from the following group: sinusoidal, and pulsed.

13. The pipe location system as recited in claim 5, wherein said transmitter detector has characteristics selected from the following group: mechanical-electrical, acoustic-electrical, and ground contacting.

14. The pipe location system as recited in claim 6, wherein said receiver detector has characteristics selected from the following group: mechanical-electrical, acoustic-electrical, and ground contacting.

15. A pipe location system for determining the location of non-conductive pipes, comprising:
a transmitter, for generating a periodic signal for coupling to the pipe and sending a reference signal to the receiver;
a sinusoidal, pulsed, periodic signal generator, for generating signals to be coupled into the pipe and transmitted to the receiver;
an electrical-mechanical transmitter transducer, for converting the electrical signal to a mechanical signal and coupling the mechanical signal from the transmitter into the pipe;
a reference transmitter, for transmitting the reference signal to the receiver;
a mechanical-electrical, acoustic-electrical, ground contacting transmitter detector, for detecting the local signal from the pipe and converting the signal into an electrical signal;
a receiver, for receiving the reference signal and detecting the signal from the pipe;
a wireless, wireline reference link, for coupling the reference signal from the transmitter to the receiver;
a mechanical-electrical, acoustic-electrical, ground contacting receiver detector, for detecting the remote signal from the pipe and converting the acoustic signal to an electrical signal;
a reference receiver, for detecting the signal from the reference link;
a lock-in amplifier synchronous detector, for extracting the detected signal from the pipe from background noise;
a visual, audio, electrical received signal strength indicator, for indicating the relative strength of the signal from the pipe; and
an optimization routine, for optimizing the signal for maximum propagation under specific soil conditions.
